(19) United States
(12) Patent Application Publication
(10) Pub. No.: US 2005/0047502 A1
(43) Pub. Date: Mar. 3, 2005

(54) Method and apparatus for the efficient representation of interpolated video frames for motion-compensated coding

(76) Inventor: James William McGowan, Whitehouse Station, NJ (US)

Correspondence Address: Lucent Technologies Inc.;Docket Administrator (Room 3J-219), Docket Administrator, 101 Crawfords Corner Road, Holmdel, NJ, 07733-3030, US

(21) Appl. No.: 10/639,259

(22) Filed: Aug. 12, 2003

(51) Int. Cl. H04N 7/12

(52) U.S. Cl. 375/240.01

(57) ABSTRACT

An efficient representation of an interpolated video frame when used with Single-Instruction-Multiple-Data processors implementing motion-compensated coding. The pixel data of a half-pixel interpolated video frame is stored in memory so that the full-pixels of the original image are stored in a first set of contiguous memory locations; the half-pixels interpolated between horizontally adjacent full-pixels are stored in a second set of contiguous memory locations; the half-pixels interpolated between vertically adjacent full-pixels are stored in a third set of contiguous memory locations; and the half-pixels interpolated between diagonally adjacent full-pixels are stored in a fourth set of contiguous memory locations.

### FIELD OF THE INVENTION

The present invention relates generally to the field of video compression techniques, and in particular to a method and apparatus for the efficient representation of interpolated video frames particularly for use in motion-compensated coding.

### BACKGROUND OF THE INVENTION

In video compression, video encoding is a major computational bottleneck. The demands of video processing have been a significant driver in the design of processors, computer systems, and communication networks, and will continue to be an increasingly important design specification as video applications, such as real-time video delivered over the Internet, become more common. Some of these applications are particularly demanding of computational resources, and so, to make these applications available to more consumers, very efficient implementations of the encoding algorithms are required.

In fact, compression and decompression of sequences of video images, either for transport over communications networks such as the Internet or for compact storage (e.g., on DVDs), has been a subject of significant interest for a number of years. In particular, a number of compression (also referred to as coding) standards have been defined, such as ITU-T H.263, a recommendation promulgated by the International Telecommunication Union, and MPEG-1, MPEG-2 (the current DVD standard) and MPEG-4, which are standards promulgated by the Moving Picture Experts Group, as well as the widely-anticipated H.264 (also known as MPEG-4 AVC), the newest video compression standard. This latest standard was created in a joint development project between the ITU and ISO (The International Organization for Standardization) bodies, and is expected to replace MPEG-2 as the most widely deployed standard. More efficient designs are required to allow cheaper and smaller systems to handle the computational demands of H.264.

One way in which such video compression schemes achieve high compression rates is by utilizing “motion compensation” or “motion estimation” between frames. Specifically, most codecs (i.e., coding/decoding systems) including those implementing the standards listed above are block based—that is, they divide each image (i.e., video frame) into square or rectangular blocks of, for example, 8-by-8 or 16-by-16 “pixels”. (As is well known to those of ordinary skill in the art, a “pixel” is an individual picture element.) Then, many portions of the video compression algorithm proceed on each block individually. Motion estimation in particular is a process of matching a portion of the image in one frame to a block in a subsequent (or sometimes preceding) image. By identifying such “matches” (or near matches), the frame being coded can be represented far more efficiently, thereby achieving improved compression ratios.

Accurate motion estimation, however, often makes use of a sub-pixel representation of the video frame. Sub-pixel accuracy is a required component of many of the major standards-based video compression schemes, including the above-mentioned H.263, MPEG-1,2 and 4, as well as the widely-anticipated H.264. Such sub-pixel accuracy is advantageous because it enables the motion estimation process to be performed with a finer resolution, thereby increasing the likelihood that a good “match” will occur. In other words, the technique is used to increase an m-by-n pixel image, for example, into a larger, higher-resolution image, such as, for example, a 2m-by2n pixel image. Then, the subsequent (or preceding) block to be matched against the current video frame is compared (i.e., conceptually overlaid) at each possible sub-pixel location (typically within a limited range of locations), thereby providing a finer resolution for the matching process. (Note, however, that typically, only the current video frame is interpolated—the blocks to be matched have only the original “resolution”.)

Specifically, sub-pixel representation is generated by interpolating “half-pixel” data elements between two regular image pixels, thereby creating an image which has the appearance of being a higher resolution image. In many algorithms, half-pixels, quarter-pixels, and even eighth-pixels may be calculated. Note that a half-pixel representation increases an m-by-n pixel image into roughly 2m-by-2n pixels, which is a four-fold increase in size, while an eighth-pixel representation requires almost 64 times the memory of the original image.

When interpolated video frames are generated in a video coder, it is typical that the resultant pixel data (including the interpolated data) which represents the resultant interpolated (i.e., expanded) video frame or portion (e.g., block) thereof is laid out in memory essentially as one would see it (or, equivalently, as a camera would have scanned it)—from left to right (first) and (then) top to bottom, wrapping around from one line to the next one below it, until all lines of the frame (or block) have been included.

In other words, in the case of half-pixel images for example, the representation in memory is typically no different than that of the original image (i.e., its full-pixel counterpart), being laid out in memory as one would see it with the interpolated half-pixel data placed “properly” between the original full pixel data, and lines containing only interpolated half-pixel data placed “properly” between the lines which include the original data. In this way, the half-pixel image appears as merely an enlarged version of the original image, having the same representation that would exist if the original frame had actually had the increased resolution in the first instance. Clearly, this is quite a natural and obvious way to represent the data, making access to the individual data elements easy and convenient.

### SUMMARY OF THE INVENTION

The present inventor recognized that the use of an alternative organization of the data representation of an interpolated video frame will advantageously result in a significantly more efficient coding process when modern “high-end” processors are used in implementing the codec. In particular, note that many modern processors are specifically optimized for the simultaneous processing of multiple data elements contained in contiguous memory locations. (Such processors are typically referred to as “SIMD” or “Single-Instruction-Multiple-Data” processors.)

More specifically, the commands of an SIMD processor work by grabbing a relatively large part of memory, such as 64 bits, and operating on 8-bit, 16-bit or 32-bit segments thereof as if they were individual pieces of data. For a non-SIMD instruction, for example, when a register A is added to a register B, the contents of both registers A and B are treated as 64-bit numbers, and a 64-bit result is returned. In an SIMD instruction, on the other hand, register A and B may, for example, be treated as representing 4 separate 16-bit numbers each. Then, each of these 16-bit numbers may be added individually, producing 4 separate 16-bit numbers as a result. Note that in this example, the execution of the SIMD instruction is 4 times faster than executing four instructions with 16-bit data, since 4 commands are executed in parallel, resulting in substantial performance gains. In this way SIMD can increase execution speed by up to 4 times for instructions operating on 16-bit numbers, or 8 times for instructions executing on 8-bit numbers, which is often the case with video and image processing. Other features of these instructions, such as overflow and underflow saturation, further increase the speed of execution significantly, making their use desirable whenever possible.

Therefore, the present invention specifically recognizes that typical motion estimation techniques, when used in concert with a traditional layout of pixel data for an interpolated video frame, results in a highly inefficient use of the capabilities of modern processors with built-in SIMD processing techniques. Specifically, when an interpolated frame is used in motion estimation, a block from a subsequent (or preceding) frame, which does not include interpolated pixel data, is compared to either only the full-pixels of the interpolated image or to only certain ones of the half-pixels of the interpolated image (i.e., those which have been interpolated between original horizontally adjacent pixels, those which have been interpolated between original vertically adjacent pixels, or those which have been interpreted between diagonally adjacent pixels). The traditional (prior art) memory layout of the interpolated image, however, interleaves full-pixels and half-pixels, thereby requiring that the pixels be disentangled before an SIMD instruction can operate efficiently thereupon (since, as explained above, SIMD instructions require that the multiple data items upon which they operate are found in contiguous memory locations). Otherwise, every other pixel (in the case of half-pixel interpolation) or more (in the case of quarter-pixel or eighth-pixel interpolation) will result in a “wasted” portion of the SIMD operation.

As such, in accordance with an illustrative embodiment of the present invention, the pixel data of an interpolated video frame is advantageously stored in memory so that full-pixels are located contiguously with other full-pixels, and half-pixels are located contiguously with the appropriate other half-pixels, so that SIMD are advantageously used efficiently, thereby increasing the execution speed of the coding process considerably. More particularly, in accordance with an illustrative embodiment of the present invention in which half-pixel interpolations are employed, the full-pixels of the original image or portion (e.g., block) thereof are stored in a first set of contiguous memory locations; the half-pixels corresponding to data interpolated between horizontally adjacent full-pixels of the original image or portion (e.g., block) thereof are stored in a second set of contiguous memory locations; the half-pixels corresponding to data interpolated between vertically adjacent full-pixels of the original image or portion (e.g., block) thereof are stored in a third set of contiguous memory locations; and the half-pixels corresponding to data interpolated between diagonally adjacent full-pixels of the original image or portion (e.g., block) thereof are stored in a fourth set of contiguous memory locations.

### BRIEF DESCRIPTION OF THE DRAWINGS

FIG. 1 shows a portion of an illustrative image of a video frame.

FIG. 2 shows a portion of an illustrative image of a video frame which has been interpolated to a half-pixel representation.

FIG. 3 shows a portion of an illustrative interpolated video frame as it might be stored in a memory in accordance with a prior art approach.

FIG. 4 shows a portion of an illustrative interpolated video frame as it is stored in a memory in accordance with an illustrative embodiment of the present invention; FIG. 4A shows the full-pixels of the illustrative video frame stored in a first set of contiguous memory locations; FIG. 4B shows the half-pixels corresponding to data interpolated between horizontally adjacent full-pixels of the illustrative video frame stored in a second set of contiguous memory locations; FIG. 3C shows the half-pixels corresponding to data interpolated between vertically adjacent full-pixels of the illustrative video frame stored in a third set of contiguous memory locations; and FIG. 4D shows the half-pixels corresponding to data interpolated between diagonally adjacent full-pixels of the illustrative video frame stored in a second set of contiguous memory locations.

FIG. 5 shows a flowchart of a method of generating a data structure representing an interpolated video frame for storage in a memory in accordance with an illustrative embodiment of the present invention.

### DETAILED DESCRIPTION

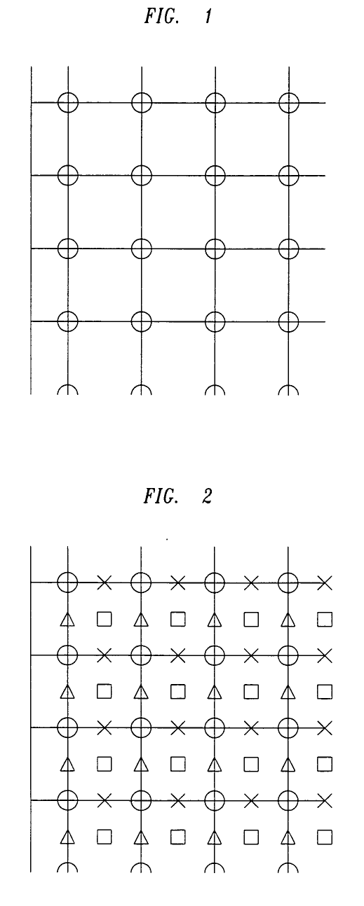

FIG. 1 shows a portion of an illustrative image of a video frame. Each dot in the figure (located at the intersection of a pair of perpendicular lines) represents the location of a pixel in the original image. Note that an image is typically represented as a 2-dimensional collection of pixels with particular “values” for the brightness and/or color of each pixel.

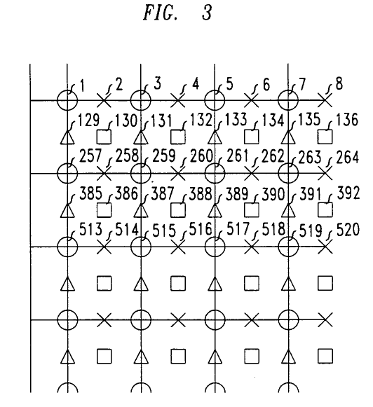

FIG. 2 shows a portion of an illustrative image of a video frame which has been interpolated to a half-pixel representation. In particular, the figure shows both the original full-pixels and all of the half-pixels that would be calculated for such a (half-pixel) interpolated image. Generating half-pixel representations may be computationally intensive, although mathematically the values of these half-pixels are usually just the average of the surrounding pixel values.

Specifically, in FIG. 2 the original full-pixels are represented as dots. Half-pixels created by averaging horizontally adjacent dots are marked with an “X”. The half-pixels between any two vertical full-pixels (i.e., those created by averaging vertically adjacent dots) are marked with a triangle. And half-pixels located between diagonally adjacent full-pixels (i.e., those on a diagonal from the full-pixels) are marked with a square. Note that, illustratively, each “X” half-pixel (i.e., those located between horizontally adjacent full-pixels) may be computed as simply the mathematical average of the full-pixel to its left and to its right; each “triangle” half-pixel (i.e., those located between vertically adjacent full-pixels) may be computed as simply the mathematical average of the full-pixel below it and above it; and each “square” half-pixel may be computed as the mathematical average of all four full-pixels on its diagonals.

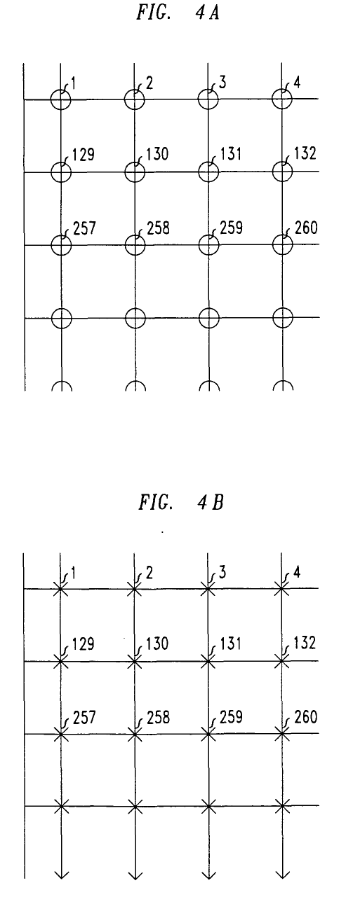

FIG. 3 shows a portion of an illustrative interpolated video frame as it might be stored in a memory in accordance with a typical prior art approach. In particular, a typical assignment of the pixel data (including the interpolated half-pixels) to consecutive memory locations is shown by the numbering associated with the pixels of the image as shown in FIG. 3. The interpolated image is assumed to be a 128 pixel by 128 pixel image, and the pixels are numbered according to the traditional method of assigning all of the pixels in the first row to the first set of consecutive memory locations, followed by all of the pixels in the second row, etc. (Note that only a portion of the 128 pixels in each row are shown.) Thus, the last pixel in the first row (not shown in the figure) is numbered 128, and the first pixel in the second row is numbered 129, thereby indicating that they are located in consecutive memory locations.

There may be more than one specific prior art approach to arranging the half-pixels of an interpolated image in memory, but all require that a larger half-pixel “image” such as that shown in FIGS. 2 and 3 be created. More particularly, there are variations as to the numbering of the rows, and whether the whole pixel values are copied into the half-pixel image from a different full-pixel-only representation. But common to all such prior art representations is the fact all of the pixels—both the original full-pixels and all of the half-pixels—are stored in a single data structure representative of the (increased resolution) half-pixel image.

Note, however, that the original full-pixel image and each of the three different half-pixel symbols shown in FIGS. 2 and 3 can actually be advantageously considered to be indicative of four different “half-pixel images”, each of which is either the original full-pixel image or a slightly displaced version thereof (assuming a perfect interpolation). In particular, note, for example, that an image created by displaying only the half-pixels represented by triangles would be the same “size” as the original full-pixel image. In many cases, video codecs consider one of these three half-pixel images individually, one at a time. For example, as pointed out above, motion estimation almost invariably is performed by comparing a block of a subsequent (or preceding) frame with the interpolated image. Since the block being compared typically has the (smaller) size of the original image, it can be directly compared to either the full-pixel image (containing only the original pixel data) or to one of the three half-pixel images (i.e., the “X” half-pixels, the “triangle” half-pixels or the “square” half-pixels) at a time.

Moreover, note that at no time (at least during, for example, the motion estimation process) is it necessary that any combination of two or more of the “half-pixel images” (including the original full-pixel image) be considered together as a group. Thus, in accordance with the illustrative embodiment of the present invention, the full-pixel image and each of the three half-pixel images are advantageously kept separately in memory, the pixel data (i.e., of the full-pixels or of the half-pixels, as the case may be) for each one of the four images being held in consecutive memory locations, thereby taking full advantage of the efficiency enhancements provided by SIMD processors.

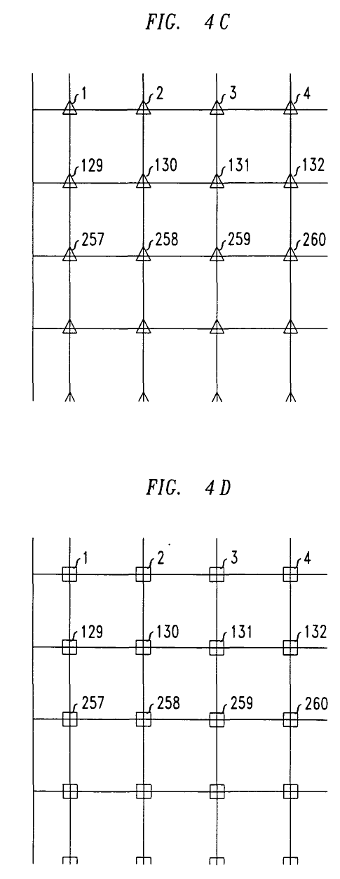

FIG. 4 shows a portion of an illustrative interpolated video frame as it is stored in a memory in accordance with an illustrative embodiment of the present invention. Specifically, FIG. 4A shows the full-pixels of the illustrative video frame stored in a first set of contiguous memory locations; FIG. 4B shows the half-pixels corresponding to data interpolated between horizontally adjacent full-pixels of the illustrative video frame stored in a second set of contiguous memory locations; FIG. 3C shows the half-pixels corresponding to data interpolated between vertically adjacent full-pixels of the illustrative video frame stored in a third set of contiguous memory locations; and FIG. 4D shows the half-pixels corresponding to data interpolated between diagonally adjacent full-pixels of the illustrative video frame stored in a second set of contiguous memory locations.

Advantageously, the embodiment of the present invention represents each of pixel “types” from the four different “half-pixel images” (as described above) in entirely separate locations in memory. Within each of these four images, the pixels are advantageously located in consecutive memory locations. Note that between these different “half-pixel images” there is no particular requirement on memory arrangement. This is specifically shown in FIGS. 4A through 4D. FIG. 4A is, in fact, the original image, which only has full pixels and may, for example, be left in its original location in memory. FIG. 4B has only the horizontally displaced half-pixels, and FIGS. 4C and 4D show the vertically and diagonally displaced pixels, respectively. Note that the numbers associated with the pixels of each of these four half-pixel images are advantageously consecutive, which allows for an efficient SIMD implementation. Note that these numbers represent memory location offsets—although each sub-FIG. 4A through 4D is numbered starting from memory location 1, each would in fact have some other arbitrary offset in memory that differs for each subfigure.

Thus, each sub-figure in FIG. 4 represents an image stored separately in memory. Since processing typically occurs on only one such image at a time, there is no advantage to storing the pixels together. Rather, by storing them separately, SIMD instructions can be used efficiently.

Note that in accordance with various illustrative embodiments of the present invention, the original full-pixel image and each of the half-pixel images, although stored separately, do not need to follow any particular internal storage arrangement of pixels within themselves. That is, although the illustrative embodiment of FIG. 4 shows the individual pixels of each of these images being stored in a conventional order (i.e., with each row of pixels stored from left to right, followed by the next row of pixels, etc.), other illustrative embodiments of the present invention may advantageously store pixels within each image in other ways.

In accordance with one particular illustrative embodiment of the present invention, for example, the original full-pixel image and each interpolated half-pixel images are advantageously stored so that the pixel data for each “sub-block” (e.g., an 8-by-8 or a 16-by-16 pixel block used for motion compensation as described above) is contiguous. Such a storage arrangement is described in detail in co-pending patent application Ser. No. 10/464,727, entitled “Method and Apparatus for the Efficient Representation of Block-Based Images,” filed on Jun. 18, 2003 by James William McGowan and commonly assigned to the assignee of the present invention. Co-pending patent application Ser. No. 10/464,727 is hereby incorporated by reference as if fully set forth herein.

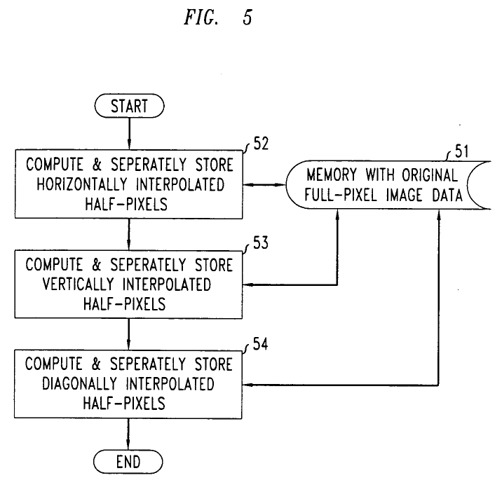

FIG. 5 shows a flowchart of a method of generating a data structure representing an interpolated video frame for storage in a memory in accordance with an illustrative embodiment of the present invention. Given an original full-pixel image, stored in a first set of contiguous locations in memory (memory 51), block 52 of the procedure of FIG. 5 computes horizontally interpolated half-pixels between each pair of horizontally adjacent full-pixels of the full-pixel image, storing all of these horizontally interpolated half-pixels in a second set of contiguous memory locations in memory 51. Then, block 53 of the procedure of FIG. 5 computes vertically interpolated half-pixels between each pair of vertically adjacent full-pixels of the full-pixel image, storing all of these vertically interpolated half-pixels in a third set of contiguous memory locations in memory 51. And finally, block 54 of the procedure of FIG. 5 computes diagonally interpolated half-pixels between each pair of diagonally adjacent full-pixels of the full-pixel image, storing all of these diagonally interpolated half-pixels in a fourth set of contiguous memory locations in memory 51. (Illustratively, the horizontally interpolated half-pixels may be computed by averaging the values of the corresponding pair of horizontally adjacent full-pixels, the vertically interpolated half-pixels may be computed by averaging the values of the corresponding pair of vertically adjacent full-pixels, and the diagonally interpolated half-pixels may be computed by averaging the values of the corresponding set of four diagonally adjacent full-pixels.) Thus, upon the completion of the procedure of FIG. 5, memory 51 contains four (separate) sets of contiguous memory locations, one comprising the original full-pixel image and each of the other three comprising a corresponding one of the three half-pixel images resulting from the interpolation thereof.

Addendum to the Detailed Description

It should be noted that all of the preceding discussion merely illustrates the general principles of the invention. It will be appreciated that those skilled in the art will be able to devise various other arrangements, which, although not explicitly described or shown herein, embody the principles of the invention, and are included within its spirit and scope. For example, although the above-described embodiment of the present invention has been presented with respect to half-pixel representations of a video frame, it will be obvious to those of ordinary skill in the art that the principles of the present invention can be easily extended to quarter-pixel interpolations, eighth-pixel interpolations, etc.

Furthermore, all examples and conditional language recited herein are principally intended expressly to be only for pedagogical purposes to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. It is also intended that such equivalents include both currently known equivalents as well as equivalents developed in the future—i.e., any elements developed that perform the same function, regardless of structure.

Thus, for example, it will be appreciated by those skilled in the art that any flow charts, flow diagrams, state transition diagrams, pseudocode, and the like represent various processes which may be substantially represented in computer readable medium and so executed by a computer or processor, whether or not such computer or processor is explicitly shown. Thus, the blocks shown, for example, in such flowcharts may be understood as potentially representing physical elements, which may, for example, be expressed in the instant claims as means for specifying particular functions such as are described in the flowchart blocks. Moreover, such flowchart blocks may also be understood as representing physical signals or stored physical data, which may, for example, be comprised in such aforementioned computer readable medium such as disc or semiconductor storage devices.

1. A method of generating a data structure for storage in a computer-readable memory having sequentially identifiable memory cell locations, the data structure representative of a video frame and including both original pixel data associated with the video frame and interpolated pixel data associated with the video frame, the interpolated pixel data representative of intermediate pixel locations interspersed between two or more pixels represented by said original pixel data, the method comprising the steps of:
storing the original pixel data associated with the video frame in a first sequential subset of said memory cell locations of said memory; and
storing at least a portion of the interpolated pixel data associated with the video frame in a second sequential subset of said memory cell locations of said memory, said second sequential subset of said memory cell locations of said memory being disjoint from said first sequential subset of said memory cell locations of said memory.

2. The method of claim 1 wherein said interpolated pixel data comprises half-pixel data representative of pixel locations interspersed halfway between associated pairs of adjacent original pixels represented by corresponding elements of said original pixel data.

3. The method of claim 1 wherein said interpolated pixel data associated with the video frame comprises a plurality of subsets of said interpolated pixel data, each subset of said interpolated pixel data representative of a different subset of said intermediate pixel locations interspersed between two or more pixels represented by said original pixel data, and wherein said step of storing at least a portion of the interpolated pixel data associated with the video frame comprises storing each of said subsets of said interpolated pixel data in a different sequential subset of said memory cell locations of said memory, each of said different sequential subsets of said memory cell locations of said memory being disjoint from each other and from said first sequential subset of said memory cell locations of said memory.

4. The method of claim 3 wherein said plurality of subsets of said interpolated pixel data include a set of horizontally interpolated pixel data, a set of vertically interpolated pixel data, and a set of diagonally interpolated pixel data, and wherein said step of storing at least a portion of the interpolated pixel data associated with the video frame comprises storing said set of horizontally interpolated pixel data in said second sequential subset of said memory cell locations of said memory, storing said set of vertically interpolated pixel data in a third sequential subset of said memory cell locations of said memory, and storing said set of diagonally interpolated pixel data in a fourth sequential subset of said memory cell locations of said memory.

5. The method of claim 1 further comprising the step of calculating said interpolated pixel data associated with the video frame based on said original pixel data associated with the video frame.

6. A computer-readable memory containing a data structure, the memory having sequentially identifiable memory cell locations, the data structure representative of a video frame and including both original pixel data associated with the video frame and interpolated pixel data associated with the video frame, the interpolated pixel data representative of intermediate pixel locations interspersed between two or more pixels represented by said original pixel data, wherein:
the original pixel data associated with the video frame has been stored in a first sequential subset of said memory cell locations of said memory; and
at least a portion of the interpolated pixel data associated with the video frame has been stored in a second sequential subset of said memory cell locations of said memory, said second sequential subset of said memory cell locations of said memory being disjoint from said first sequential subset of said memory cell locations of said memory.

7. The computer-readable memory of claim 6 wherein said interpolated pixel data comprises half-pixel data representative of pixel locations interspersed halfway between associated pairs of adjacent original pixels represented by corresponding elements of said original pixel data.

8. The computer-readable memory of claim 6 wherein said interpolated pixel data associated with the video frame comprises a plurality of subsets of said interpolated pixel data, each subset of said interpolated pixel data representative of a different subset of said intermediate pixel locations interspersed between two or more pixels represented by said original pixel data, and wherein each of said subsets of said interpolated pixel data has been stored in a different sequential subset of said memory cell locations of said memory, each of said different sequential subsets of said memory cell locations of said memory being disjoint from each other and from said first sequential subset of said memory cell locations of said memory.

9. The computer-readable memory of claim 8 wherein said plurality of subsets of said interpolated pixel data include a set of horizontally interpolated pixel data, a set of vertically interpolated pixel data, and a set of diagonally interpolated pixel data, and wherein said set of horizontally interpolated pixel data has been stored in said second sequential subset of said memory cell locations of said memory, said set of vertically interpolated pixel data has been stored in a third sequential subset of said memory cell locations of said memory, and said set of diagonally interpolated pixel data has been stored in a fourth sequential subset of said memory cell locations of said memory.

10. The computer-readable memory of claim 6 wherein said interpolated pixel data associated with the video frame has been calculated based on said original pixel data associated with the video frame.
